(19) United States
(12) Patent Application Publication
(10) Pub. No.: US 2009/0301174 A1
(43) Pub. Date: Dec. 10, 2009

(54) Cooling system pressure tester

(76) Inventor: Deming Wen, Las Vegas, NV (US)

Correspondence Address: JAMES RAY & ASSOCIATES, 2640 PITCAIRN ROAD, MONROEVILLE, PA, 15146, US

(21) Appl. No.: 12/157,431

(22) Filed: Jun. 10, 2008

(51) Int. Cl. G01M 3/04

(52) U.S. Cl. 73/49.7

(57) ABSTRACT

An apparatus for checking pressure leaks in a vehicle's heating and cooling system, such system including a radiator, top and bottom hoses, a water pump, a heater, a thermostat and connecting hoses. The apparatus comprises a test head for engagement with a neck of a radiator in place of a radiator cap. There is a gauge member in fluid communication with the test head for measuring an actual pressure on such cooling system. An air control valve is in fluid communication with the test head and the gauge member for regulating how much air pressure is going to such cooling system. The apparatus, further, has a handle control member that is in fluid communication with the test head, the gauge member and the air control valve and further is in fluid communication with a shop air hose for controlling how much air pressure is going to the air control valve. There is also a hose and appropriate fittings for providing fluid communication with the test head, the gauge member, the air control valve, the handle control member and such shop air hose for providing pressurized air to such cooling system.

### FIELD OF THE INVENTION

The present invention relates, in general, to a pressure tester, and, more particularly, the present invention relates to an cooling system pressure tester for diagnosing where such cooling system is leaking coolant.

### BACKGROUND OF THE INVENTION

All kind of vehicles use a cooling system to cool down the engine temperature and keep a certain pressure and temperature to let the engine run efficiently. The cooling system has a large number of parts. If some parts are defective the mechanic or technician needs to know where the system is leaking coolant so as to be able to repair it. At the present time the technicians use a hand cooling pressure tester. One problem is that it is difficult to pump air into the system to build up sufficient pressure (>11 psi). Another drawback with present testers is that they are relatively expensive.

Thus, it would be advantageous if there were a simple and effective means of testing for coolant leaks in a a vehicle's cooling system.

### SUMMARY OF THE INVENTION

In a first aspect the present invention provides an apparatus for checking pressure leaks in a vehicle's cooling system, such cooling system including a radiator, top and bottom hoses, a water pump, a heater and a thermostat as well as connecting hoses. Such apparatus comprises a test head for engagement with a neck of a radiator in place of a radiator cap. There is a gauge member in fluid communication with the test head for measuring an actual pressure on such cooling system. An air control valve is in fluid communication with the test head and the gauge member for regulating how much air pressure is going to such cooling system. The apparatus, further, has a handle control member that is in fluid communication with the test head, the gauge member and the air control valve and further is in fluid communication with a shop air hose for controlling how much air pressure is going to the air control valve. There is also a fluid communication means for engagement with the test head, the gauge member, the air control valve, the handle control member and such shop air hose for providing pressurized air to such cooling system.

### OBJECTS OF THE INVENTION

It is, therefore, one of the primary objects of the present invention to provide an apparatus for pressure testing a vehicle's cooling system that is easy to use.

Another object of the present invention is to provide an apparatus for pressure testing a vehicle's cooling system that utilizes air from a shop air hose.

Still another object of the present invention is to provide an apparatus for pressure testing a vehicle's cooling system that has a handle control valve for holding and releasing pressure to the system.

Another object of the present invention is to provide an apparatus for pressure testing a vehicle's cooling system that holds the pressure and slowly releases such pressure on the cooling system by using the test head.

Yet another object of the present invention is to provide an apparatus for pressure testing a vehicles cooling system that provides safeguards for the cooling system.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a top perspective view of the apparatus for pressure testing a vehicle's cooling system according to an embodiment of the invention.

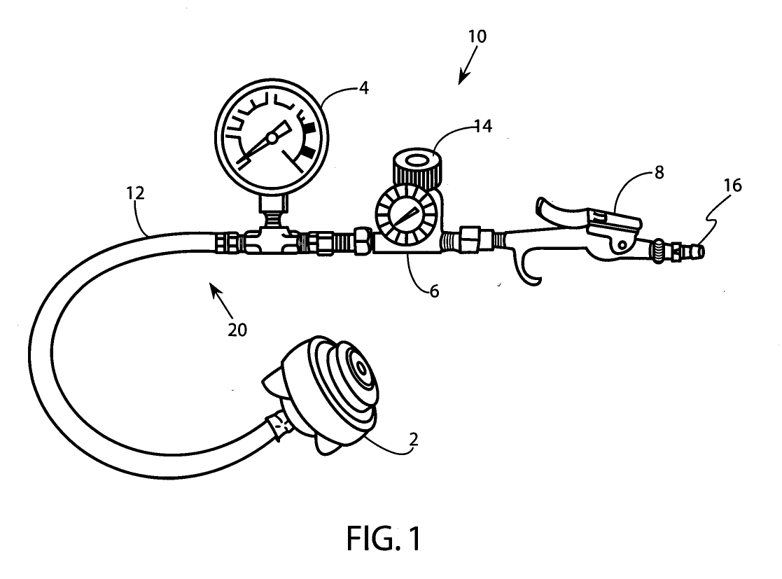

FIG. 2 is a is an enlarged perspective view of the handle member of the apparatus shown in FIG. 1.

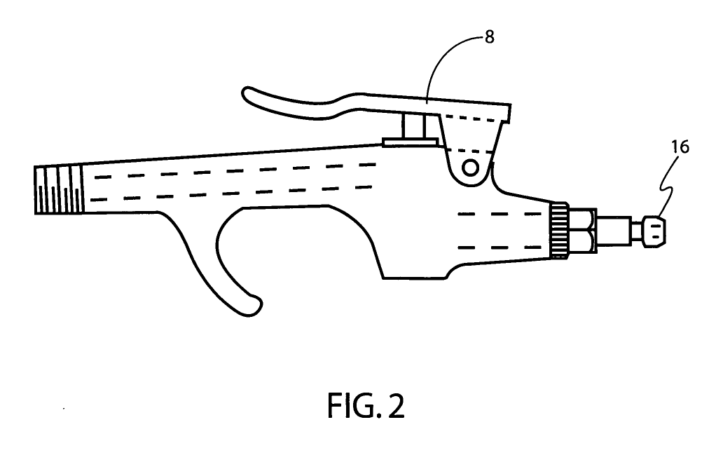

FIG. 3 is an enlarged perspective view of the test head of the apparatus shown in FIG. 1.

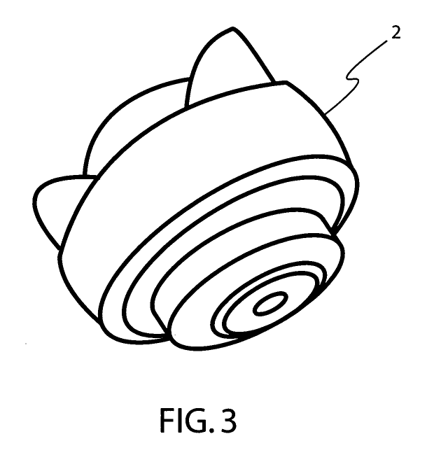

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10 for checking pressure leaks in a vehicle's cooling system, such cooling system including a radiator, top and bottom hoses, a water pump and a thermostat. Such apparatus 10 comprises a test head 2 for engagement with a neck of a radiator in place of a radiator cap. There is a gauge member 4 in fluid communication with the test head for measuring the actual pressure on such cooling system. An air control valve 6 is in fluid communication with the test head 2 and the gauge member 4 for regulating how much air pressure is going to such cooling system. The apparatus 10, further, has a handle control member 8 that is in fluid communication with the test head 2, the gauge member 4 and the air control valve 6 and further is in fluid communication with a shop air hose for controlling how much air pressure is going to the air control valve 6. There is also a fluid communication means, generally designated 20, for engagement with the test head 2, the gauge member 4, the air control valve 6, the handle control member 8 and such shop air hose for providing pressurized air to such cooling system.

In a presently preferred embodiment of the invention such fluid communication means 20 includes a hose 12 and associated fittings. One of such fittings 16 is designed for engagement with shop air hose.

Such test head 2 will lock or unlock the apparatus 10 to such radiator neck. The test head 2 is used to relieve pressure to the cooling system when such test is completed

The air control valve 6 regulates the air pressure from zero to 90 psi that is being applied to such cooling system. The amount of pressure being applied is dependent on such vehicle's cooling system and the manufacturer's design. The air control valve 6 has an adjustment knob 14 for controlling or setting such air pressure being used to pressurize such cooling system.

The handle control member 8 further secures such air pressure in such cooling system when such shop air hose is disconnected. The handle control member 8 when activated prevents the pressure from escaping in the event that the shop air line is disconnected to the system. The handle control member 8 further acts as a second safety valve for controlling the air pressure.

Thus the present invention provides an apparatus for checking for leaks in a vehicle's cooling and heating system. If leakage occurs and is not corrected the engine can be damaged in relatively short order. The apparatus 10 of the present invention is easy to use by any technician to find a leak. By using shop air the apparatus has a supply of pressurized air that is readily available and eliminates the problem encountered where the leak tester is pumped up by hand, which makes it difficult to obtain the pressure needed to perform a good test.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for checking pressure leaks in a vehicle's cooling and heating system, such system including a radiator, top and bottom hoses, a water pump, a heater, a thermostat and connecting hoses, said apparatus comprising:
(a) a test head for engagement with a neck of a radiator in place of a radiator cap;
(b) a gauge member in fluid communication with said test head for measuring an actual pressure on such cooling system;
(c) an air control valve in fluid communication with said test head and said gauge member for regulating how much air pressure is going to such cooling system;
(d) a handle control member in fluid communication with said test head, said gauge member and said air control valve and further in fluid communication with a shop air hose for controlling how much air pressure is going to said air control valve, and
(e) a fluid communication means for engagement with said test head, said gauge member, said air control valve, said handle control member and such shop air hose for providing pressurized air to such cooling system.

2. The apparatus, according to claim 1 wherein said fluid communication means includes a hose and associated fittings.

3. The apparatus, according to claim 1, wherein said test head one of locks and unlocks said apparatus to such radiator neck.

4. The apparatus, according to claim 1, wherein said air control valve regulates air pressure from zero to 90 psi being applied to such cooling system depending on such vehicle's cooling system and manufacturer's design.

5. The apparatus, according to claim 4, wherein said air control valve includes an adjustment knob for controlling such air pressure being used to pressurize such cooling system.

6. The apparatus, according to claim 5, wherein said handle control member further secures such air pressure in such cooling system when such shop air hose is disconnected.

7. The apparatus, according to claim 1, wherein said test head further releases air pressure after such cooling system has been checked for leaks.

8. The apparatus, according to claim 2, wherein said associated fittings includes a fitting for engagement with such shop air hose.
